(19) United States
(12) Patent Application Publication
(10) Pub. No.: US 2024/0368017 A1
(43) Pub. Date: Nov. 7, 2024

(54) METHOD OF TREATING A GLASS RIBBON AND APPARATUS THEREFOR

(71) Applicant: CORNING INCORPORATED, CORNING, NY (US)

(72) Inventors: Tomohiro Aburada, Painted Post, NY (US); Kaushik Arumbuliyur Comandur, Birmingham (GB); Ivan Fedorovich Melikhov, Avon (FR)

(21) Appl. No.: 18/684,751

(22) PCT Filed: Sep. 9, 2022
(86) PCT No.: PCT/US2022/042975

§ 371 Date: Feb. 19, 2024

Related U.S. Application Data
(60) Provisional application No. 63/246,979, filed on Sep. 22, 2021.

(51) Int. Cl. C03B 17/06

(52) U.S. Cl. CPC C03B 17/068; C03B 17/067

(57) ABSTRACT

A method and an apparatus for forming and treating a glass ribbon. The apparatus includes a treatment roller and an edge roller that contacts an edge portion of a layer of glass disposed on the treatment roller. The edge roller cools the edge portion of the glass layer, the cooled edge portion attaining an increased viscosity compared to a center portion of the glass layer. Embodiments may include a second edge roller that contacts and cools an opposing edge portion of the glass layer. The cooled edge portions can resist widthwise contraction of the glass layer and the glass ribbon formed therefrom.

### CROSS-REFERENCE TO RELATED APPLICATIONS

This application claims the benefit of priority under 35 U.S.C. § 119 of U.S. Provisional Application Ser. No. 63/246,979, filed on Sep. 22, 2021, the content of which is relied upon and incorporated herein by reference in its entirety.

### FIELD

The present disclosure relates to a method of treating a glass ribbon, and more particularly to a method of reducing contraction of the glass ribbon in a width direction of the ribbon. An apparatus for practicing the method is also disclosed.

### BACKGROUND

It is known to treat a stream of molten glass by flowing the molten glass over a treatment roller for at least a portion of a circumference of the treatment roller, during which time the layer of molten glass on the treatment roller is cooled by the treatment roller and released therefrom. The layer of molten glass can be drawn from the treatment roller by pulling rolls positioned below the treatment roller, the pulling rolls applying a downward tension on the molten glass to produce a glass ribbon of desired thickness. As the molten glass layer cools on the treatment roller and below, the molten glass layer, and the glass ribbon, can contract in a width direction of the glass, reducing the overall width of the glass ribbon and thereby reducing the useable width of the glass ribbon.

### SUMMARY

FIG. 1 is a schematic view of a glass forming apparatus wherein a stream of molten glass 10 is provided from a vessel 12 configured to deliver the molten glass to a treatment roller 14. The stream of molten glass is released from the treatment roller and drawn downward by pairs of counterrotating pulling rolls 16. As the layer of molten glass in contact with the treatment roller cools, contraction forces (e.g., surface tension) may cause the opposing edges 18 and 22 of the glass stream to attenuate inward, as shown by arrows 24, increasing a thickness of the edges 18, 22 and reducing the overall width of the molten glass layer. Such contraction may continue until a temperature of the glass ribbon is sufficiently low (and the ribbon edges sufficiently stiff) that further contraction will not occur. The thickened edge portions of the glass ribbon are unsuitable for sale and must be removed, thereby further reducing the useable width 26 of the glass ribbon and of glass sheets removed therefrom.

Accordingly, a method of forming a glass ribbon while minimizing widthwise contraction is disclosed comprising flowing a stream of molten glass on an outer surface of a treatment roller rotating about a first axis of rotation in a first direction of rotation, the stream of molten glass forming a molten glass layer on the outer surface of the treatment roller, contacting an edge portion of the molten glass layer on the treatment roller with a first edge roller rotating about a second axis of rotation in a second direction of rotation opposite the first direction of rotation, the contacting cooling the edge portion and increasing a viscosity thereof, the molten glass layer leaving the treatment roller as a ribbon of molten glass. The first edge roller does not contact a central portion of the molten glass layer. The stream of molten glass may be flowed, for example, from a forming body. In some embodiments, the forming body can comprise a slot from which the stream of molten glass is discharged. In other embodiments, the forming body may comprise a forming wedge, the forming wedge comprising a trough in an upper surface of the forming body and a pair of inclined forming surfaces that converge along a bottom edge of the forming wedge. Molten glass overflows the trough, descends along the converging forming surfaces, and joins at the bottom edge to form the glass stream.

The method further comprises drawing the ribbon of molten glass from the treatment roller in a draw direction between a pair of pulling rolls, the pulling rolls engaging the edge portion on opposite sides of the glass ribbon below the treatment roller. In various embodiments, the method may further comprise contacting the edge portion with a pair of edge rollers positioned between the treatment roller and the pair of pulling rolls, the pair of edge rollers further cooling the edge portion.

A surface of the first edge roller can be cooled by a flow of cooling fluid within an interior of the first edge roller.

The method may further comprise cooling the treatment roller by contacting an interior surface of the first edge roller with a cooling fluid.

A diameter of the treatment roller can be in a range from about 5 cm to about 31 cm. A length of the treatment roller can be in a range from about 25 cm to about 400 cm.

A diameter of the first edge roller can be in a range from about 2.5 cm to about 8 cm. A length of the first edge roller can be in a range from about 1 cm to about 26 cm.

The treatment roller comprises a top defined at an angular position of 0 degrees. The first edge roller can contact the edge portion on the treatment roller at an angular position in a range from about 35 degrees to about 90 degrees defined in a direction of rotation of the treatment roller relative to the 0 position.

The first edge roller can be movable along the second axis of rotation.

The molten glass layer can comprise a first viscosity at a first point on the edge portion and a second viscosity at a center point of the molten glass layer on a horizontal line extending orthogonal to the draw direction, and a viscosity ratio defined as a ratio of the viscosity of the molten glass layer at the first point to the viscosity of the glass layer at the center point can be in a range from about 1 to 100, for example in a range from about 1 to about 30, such as in a range from about 1 to about 16, for example in a range from about 5 to about 15.

A method of forming a glass ribbon is also disclosed, the method comprising flowing a stream of molten glass on an outer surface of a treatment roller rotated about a first axis of rotation in a first direction of rotation by a first motor, the stream of molten glass forming a molten glass layer on the outer surface of the treatment roller, contacting an edge portion of the molten glass layer on the treatment roller with a first edge roller rotated about a second axis of rotation in a second direction of rotation opposite the first direction of rotation by a second motor, the contacting cooling the edge portion and increasing a viscosity thereof, the molten glass layer comprising a first viscosity at a first point on the edge portion and a second viscosity at a center point of the molten glass layer on a horizontal line extending orthogonal to the draw direction, and a viscosity ratio defined as a ratio of the viscosity of the molten glass layer at the first point to the viscosity of the glass layer at the center point is in a range from about 1 to about 16, the molten glass layer leaving the treatment roller as a ribbon of molten glass. The method further comprises drawing the ribbon of molten glass from the treatment roller between a pair of pulling rolls in a draw direction, the pulling rolls engaging the edge portion on opposite sides of the glass ribbon below the treatment roller. The first edge roller does not contact a central portion of the molten glass layer.

The treatment roller can extend across an entire width of the molten glass layer in a direction orthogonal to the draw direction.

A viscosity of the stream of molten glass at the treatment roller can be in a range from about 1099 poise to about 1011.2 poise.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is an elevational view of an exemplary molten glass treatment apparatus;

FIG. 2 is a schematic view of an exemplary glass making apparatus according to an embodiment of the present disclosure;

FIG. 3 is an elevational view of an exemplary molten glass forming and treatment apparatus according to an embodiment of the present disclosure wherein a treatment roller is supplied with a stream of molten glass from a forming body comprising a slot useable with the glass making apparatus of FIG. 2;

FIG. 4 is an elevational view of an exemplary molten glass forming and treatment apparatus according to an embodiment of the present disclosure wherein a treatment roller is supplied with a stream of molten glass from a forming body comprising converging forming surfaces useable with the glass making apparatus of FIG. 2;

FIG. 5 is a front elevational view of an exemplary molten glass treatment apparatus;

FIG. 6 is a cross-sectional view of an exemplary edge roller;

FIG. 7 is a schematic view of an exemplary treatment roller showing positions for an edge roller configured to contact an edge portion of a molten glass layer disposed on the treatment roller;

FIG. 8 is a schematic view of a portion of an edge portion showing an edge roller movable along a rotational axis of the edge roller;

FIG. 9 is chart showing modeling results illustrating ribbon width in millimeters as a function of edge-to-center viscosity for 5 different glass ribbon center viscosities; and

FIG. 10 is a chart showing glass ribbon width as a function of edge-to-center viscosity of the glass ribbon.

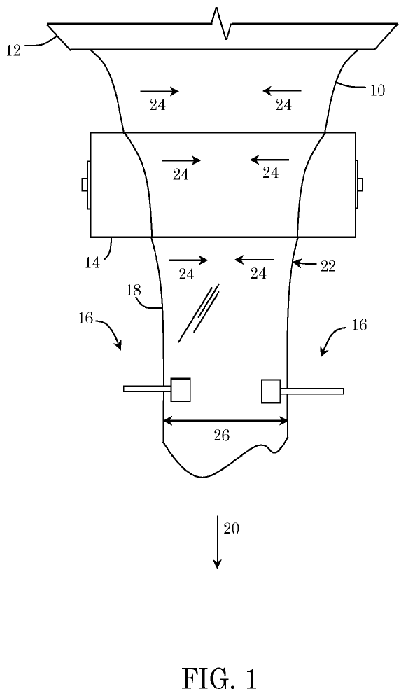

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein below, a distinction is made between a stream of molten glass (e.g., stream or glass stream), a layer of molten glass (e.g., glass layer) and a ribbon of glass (e.g., glass ribbon). As used herein, a stream of molten glass refers to the flow of molten glass from a forming body prior to contacting a downstream treatment roller. The forming body can be the discharge end of a conduit or pipe, a narrow discharge slot, for example in a refractory or metallic body, or a fusion forming body wherein molten glass overflows a trough in the body and descends from a bottom edge of the body as a stream. For the purpose of discussion, the molten glass will be referred to as a molten glass layer while in contact with a treatment roller but will be referred to as a glass ribbon after release from a surface of the treatment roller. Accordingly, a distinction is made for descriptive purposes to three phases of the molten glass: after discharge from a forming body (glass stream, stream of glass, stream of molten glass, etc.) during contact with the treatment roller (glass layer) and after release from the treatment roller (glass ribbon).

As used herein, unless otherwise indicated, the term “molten glass,” “glass,” as well as glass stream, glass layer, and glass ribbon, refer to a non-elastic, viscous material capable of being cooled to form an amorphous, elastic, glassy material, for example an inorganic glass material such as a silicate glass.

Methods disclosed herein for producing sheets of glass having two opposing major surfaces, at least one of which presents high surface quality, using a roller surface to treat the glass are particularly well adapted, although not restricted, to perform such production on glasses having a low liquidus viscosity, such as, for example, glass having a liquidus viscosity lower than about 20,000 Pa·s. As used herein, the term “liquidus viscosity” refers to the viscosity of a molten glass at the liquidus temperature, where the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed herein is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point.”

Methods disclosed herein can comprise delivering a stream of molten glass onto a treatment device (e.g., treatment roller) as a molten glass layer, treating the molten glass layer with the treatment device, the treatment device suitable, temporarily, for supporting the weight of the molten glass layer and for accompanying a falling movement of the molten glass layer while increasing a viscosity thereof and maintaining at least a central portion of one of its two major surfaces free from contact with a surface of the treatment device; using appropriate devices or mechanisms to act on the glass ribbon released from the treatment device to control its travel speed and also the width and/or the thickness of the glass ribbon; and cooling the glass ribbon.

The stream of molten glass can be generated free from any contact after leaving the forming body and can be taken up rapidly before mechanical destabilization of the stream of glass, and a viscosity thereof, is significantly increased. Such destabilization may take the form of variations in width of the stream of molten glass, lateral “walking” of the stream, separation of the stream into separate, distinct parts, and so forth. The flow can be controlled and cooled to obtain a glass ribbon having one of its major surfaces free from contact with any surface, at least in its central portion.

The stream of molten glass can be delivered to the treatment roller with a viscosity, as measured in accordance with ASTM C829-81 (2015), in a range from about 5 Pa·s to about 5,000 Pa·s (about 50 poises to about 50,000 poises), for example, about 5, 7, 9, 10, 15, 20, 40, 50, 80, 100, 200, 400, 700, 1,000, 1,500, 2,000, 2,500, 3,000, 3,500, 4,000, 4,500, or 5,000 Pa·s, for example in a range from about 10 Pa·s to 1,000 Pa·s (100 poises to 10,000 poises), such as 10, 15, 20, 40, 50, 80, 100, 200, 400, 700, or 1,000 Pa·s.

The stream of molten glass can have both major surfaces free from contact with any surface between its exit from the delivery device and the treatment device. When delivered in such a way, the stream of molten glass falls under gravity. The height through which the stream of molten glass falls is limited, as it should be taken up before it becomes unstable. The acceptable fall height between the exit of the glass stream delivery device and the treatment device depends on the glass composition in question and its dimensions. In general, the fall height does not exceed 150 millimeters (mm). For example, the fall height can be less than 60 mm. Given a particular glass composition and dimensions, the skilled person is capable of optimizing the fall height, e.g., implementing delivery of the molten glass. In an exemplary embodiment, the maximum fall height can be about 10 mm for a molten glass having a viscosity of about 100 Pa·s and wherein a thickness of the delivered stream is about 3 mm.

In accordance with embodiments disclosed herein, methods can comprise treating a delivered stream of molten glass. Before it begins to destabilize, the stream of molten glass can be taken up by the treatment device under conditions that do not themselves give rise to destabilization, and which ensure at least the central portion of one of the major surfaces of the glass remains free from contact with any surface. This major surface can remain free from or substantially free from contact with another material. Contact, if any occurs, can be limited to edge portions of the stream. The glass can be treated, such that at the end of treatment the molten glass is more viscous than on being delivered upstream, thus stabilizing the stream.

Treatment of a delivered stream of molten glass can comprise receiving the delivered stream on the surface of a treatment roller as a molten glass layer, the treatment roller presenting a suitable surface temperature and rotating in a suitable direction and at a suitable speed to accompany movement of the molten glass layer without relative displacement of the molten glass layer relative to the surface of the treatment roller. The lowest allowable speed for the treatment roller may be determined, at least in part, by the glass flow density and the distance between the exit point of the delivered stream of molten glass from the forming body and the top dead center (TDC) of the treatment roller. For example, the lowest allowable rotational speed of the treatment roller may be that rotational speed at the surface of the treatment roller that results in a linear draw rate for the glass ribbon drawn therefrom of about 0.4 centimeters/minute (cm/min). The upper limit for draw rate can be 250 cm/min or higher, or until the molten glass stream between the root and the treatment roller becomes unstable.

The surface temperature of the treatment roller can range from about 200° C. to about 800° C. and may vary depending on the thermal environment of the treatment roller and the temperature of the molten glass layer. The treatment roller can be associated with devices or mechanisms for controlling a surface temperature of the treatment roller and thus the temperature of the molten glass layer in contact therewith. The treatment roller can be positioned and driven appropriately to ensure contact with the molten glass layer and sufficient cooling of the molten glass layer to obtain the desired increase in viscosity, and that contact between the molten glass layer and the treatment roller can be maintained without relative displacement between the molten glass layer and the treatment roller over a significant fraction of the circumference of the treatment roller.

The treated glass layer can be maintained so at least a central portion of one major surface of the layer remains free from contact with another surface, such as an edge roll and/or a pulling roll.

As a glass stream contacts a roller, such as a treatment roller, an adhesive force may develop between the glass and the roller. The nature and magnitude of such an adhesive force can vary, depending on the composition of the specific glass and the roller, along with such factors as, for example, surface texture of the roller material, contact pressure of the glass layer on the roller surface, duration of contact, and temperature of the molten glass and the roller. An adhesive force may develop as a result of Van der Waals-type interactions at the glass-roller interface. If the adhesive force is too large, the contacted glass either cannot be released or cannot be released without damaging either one of the glass and/or the roller. If the adhesive force is too small, the glass can slip relative to the roller surface, resulting in variations in thickness of, and/or damage to, the glass.

Adhesive force between a roller and a molten glass layer can be utilized to compensate for the natural downward gravitational force on the molten glass layer during manufacture. The adhesive force between the molten glass layer and the roller can comprise one or more individual forces acting together. For example, in addition to adhesion of the molten glass layer to the surface of a roller, orthogonal and/or tangential forces can act on the molten glass layer in the direction of attachment. The adhesive force per unit area can be determined by one of ordinary skill in the art and subsequently utilized to determine the maximum orthogonal and/or tangential forces to which a glass layer can be subjected without resulting in separation of the molten glass layer from the roller. For example, determination of the tangential force can be performed if the static friction coefficient between the glass layer and the roller surface is known.

A relationship exists between the viscosity of a molten glass layer contacting a roller and the adhesive force that may exist between the molten glass layer and the roller after contacting. Thus, it can be desirable to control the adhesive force between the molten glass layer and the roller by controlling the interfacial temperature therebetween.

The viscosity of a molten glass layer contacting a roller, such as a treatment roller, can vary depending on glass composition and methods employed in a specific roller design. While not intending to be limiting, the viscosity of a molten glass layer contacting a roller may generally be in a range from about 10⁸ Pa·s to about 10¹⁰ Pa·s, for example, about 1×10⁸, 5×10⁸, 1×10⁹, 5×10⁹, or 1×10¹⁰ Pa·s. Glass layers with a viscosity less than about 10⁸ Pa·s may exhibit irreversible sticking between the molten glass layer and the roller. Glass layers having a viscosity of about 10⁹ Pa·s may exhibit moderate adhesive forces. Molten glass layers having a viscosity greater than about 10¹⁰ Pa·s may exhibit no, or substantially no, adhesive forces between the molten glass layer and the roller.

Interfacial temperature, and thus adhesive force, between a molten glass layer and a roller can be controlled during the manufacturing process. A particular glass manufacturing system, and specifically a roller, such as a treatment roller, can utilize any suitable method to control surface temperature of the roller, and thus interfacial temperature and resulting glass layer viscosity, including, in various embodiments, any one or more of the methods recited herein. A roller can comprise at least one channel within which a cooling fluid, such as, for example, air and/or water, can be flowed. A roller can optionally utilize other devices and/or mechanisms to control surface temperature in addition to, or alternatively to, a cooling channel. For example, a roller can be hollow, such that air and/or water can be flowed over, sprayed against, or otherwise applied to an internal wall of the roller. At least one array of external cooling nozzles can be used to control or partially control surface temperature of a roller. Thermal control of a roller surface temperature can be produced by radiation, convection, and/or conduction on at least a portion of the roller not in contact with a molten glass layer.

Thus, treatment steps may comprise adjusting and controlling the temperature of a roller, for example a treatment roller, prior to and/or while contacting a molten glass layer, such that a molten glass layer in contact with the roller surface will have a viscosity at the surface of the treatment roller in a range from about 10^{8.9} Pa·s to about 10^{10.2} Pa·s to obtain reversible adhesion between the treatment roller and the molten glass layer. The adhesion force should be reversible over the period extending from the location where the molten glass stream first contacts the treatment roller to the point where the glass layer releases from the treatment roller contact as a glass ribbon. The treating or treatment step may further optionally comprise maintaining and/or reheating the contacted glass sufficiently that any subsequent redraw (thinning) of the glass can be accomplished. The viscosity of the molten glass layer at the surface of the treatment roller can be determined by first determining a curve of viscosity as a function of temperature for the particular glass composition employed. The temperature of the molten glass layer on the treatment roller can then be measured, for example by using an optical pyrometer, and the viscosity of the molten glass calculated based on the previously determined viscosity vs. temperature curve.

To efficiently stabilize a low liquidus viscosity glass, a drawing force exerted between a roller and the molten glass layer in contact with the roller can be modified using a variety of techniques. In a first example, the surface area of the interface between a roller and a molten glass layer in contact with the roller can be modified to provide modulation of the cooling. Accordingly, the surface of the roller may be roughened to have an average roughness (Ra) in a range from 0 to about 25 micrometers as determined using a profilometer, where the average roughness is the arithmetic average value of a filtered roughness profile determined from deviations about the center line within the evaluation length. In a second example, glass can be delivered to different locations on a roller and/or from different directions. In a third example, a drawing force can be exerted in different directions. For example, pulling rolls and/or edge rollers can be used to prevent lateral contraction (attenuation) of a glass ribbon as the molten glass layer is released from the treatment roller. Each of these examples may be used separately or in any combination.

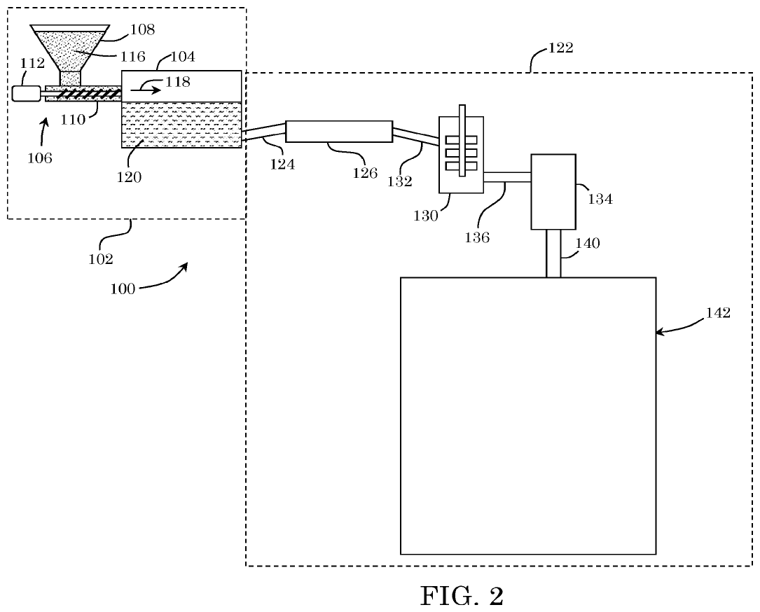

An exemplary glass manufacturing apparatus 100 is shown in FIG. 2. Glass manufacturing apparatus 100 comprises a glass melting furnace 102 including a melting vessel 104. In addition to melting vessel 104, glass melting furnace 102 may optionally include one or more additional components such as heating elements (e.g., combustion burners and/or electrodes) configured to heat raw material and convert the raw material into molten glass.

Glass melting furnace 102 may include other thermal management devices (e.g., isolation components) that reduce heat loss from the melting vessel. Glass melting furnace 102 may include electronic and/or electromechanical devices that facilitate melting of the raw material into a glass melt. Glass melting furnace 102 may include support structures (e.g., support chassis, support member, etc.) or other components.

Melting vessel 104 may be formed from a refractory material, such as a refractory ceramic material, for example a refractory ceramic material comprising alumina or zirconia, although the refractory ceramic material can comprise other refractory materials, such as yttrium (e.g., yttria, yttria-stabilized zirconia, yttrium phosphate), zircon (ZrSiO₄) or alumina-zirconia-silica or even chrome oxide, used either alternatively or in any combination. In some examples, melting vessel 104 may be constructed from refractory ceramic bricks.

Glass melting furnace 102 may be incorporated as a component of a glass manufacturing apparatus configured to fabricate a glass article, for example a glass ribbon. However, the glass manufacturing apparatus may be configured to form other glass articles as well, such as glass rods, glass tubes, glass envelopes (for example, glass envelopes for lighting devices, e.g., light bulbs) and glass lenses, although many other glass articles are contemplated. The melting furnace may be included in a glass manufacturing apparatus comprising a slot draw apparatus, a float bath apparatus, a down-draw apparatus (e.g., a fusion down draw apparatus), an up-draw apparatus, a pressing apparatus, a rolling apparatus, a tube drawing apparatus or any other glass manufacturing apparatus that would benefit from the present disclosure.

Glass manufacturing apparatus 100 may optionally include an upstream glass manufacturing apparatus 106 positioned upstream of melting vessel 104. In some examples, a portion of, or the entire upstream glass manufacturing apparatus 106, can be incorporated as part of the glass melting furnace 102.

As shown in FIG. 2, upstream glass manufacturing apparatus 106 may include a raw material storage bin 108, a raw material delivery device 110, and a motor 112 connected to raw material delivery device 110. Raw material storage bin 108 may be configured to store a quantity of raw material 116 that can be fed into melting vessel 104 of glass melting furnace 102 through one or more feed ports, as indicated by arrow 118. Raw material 116 typically comprises one or more glass forming metal oxides and one or more modifying agents. In some examples, raw material delivery device 110 may be powered by motor 112 to deliver a predetermined amount of raw material 116 from raw material storage bin 108 to melting vessel 104. In further examples, motor 112 may power raw material delivery device 110 to introduce raw material 116 at a controlled rate based on a level of molten glass sensed downstream from melting vessel 104 relative to a flow direction of the molten glass. Raw material 24 within melting vessel 104 is thereafter heated to form molten glass 120. Typically, in an initial melting step, raw material 116 is added to melting vessel 104 as particulate, for example as various “sands.” Raw material 116 may also include scrap glass (i.e., cullet) from previous melting and/or forming operations. Combustion burners are typically used to begin the melting process. In an electrically boosted melting process, once the electrical resistance of the raw material is sufficiently reduced, electric boost begins by developing an electrical potential between electrodes positioned in contact with the raw material, thereby establishing an electrical current through the raw material, the raw material typically entering, or in, a molten state. As used herein, the resultant molten material shall be referred to as molten glass 120.

Glass manufacturing apparatus 100 may optionally include a downstream glass manufacturing apparatus 122 positioned downstream of glass melting furnace 102 relative to a flow direction of molten glass 120. In some examples, a portion of downstream glass manufacturing apparatus 122 may be incorporated as part of glass melting furnace 102. However, in some instances, first connecting conduit 124 discussed below, or other portions of the downstream glass manufacturing apparatus 122, can be incorporated as part of the glass melting furnace 102.

Downstream glass manufacturing apparatus 122 may include a first conditioning (i.e., processing) chamber, such as fining vessel 126, located downstream from melting vessel 104 and coupled to melting vessel 104 by way of the above-referenced first connecting conduit 124. In some examples, molten glass 120 may be gravity fed from melting vessel 104 to fining vessel 126 through first connecting conduit 124. It should be understood, however, that other conditioning chambers may be positioned downstream of melting vessel 104, for example between melting vessel 104 and fining vessel 126. A conditioning chamber may be employed between the melting vessel and the fining chamber. For example, molten glass from a primary melting vessel may be further heated in a secondary melting (conditioning) vessel or cooled in the secondary melting vessel to a temperature lower than the temperature of the molten glass in the primary melting vessel before entering the fining vessel.

As described previously, gases may be removed from molten glass 120 by various techniques. For example, raw material 116 may include multivalent compounds (i.e., fining agents) such as tin oxide that, when heated, undergo a chemical reduction reaction and release oxygen. Other suitable fining agents can include without limitation arsenic, antimony, iron, and/or cerium, although the use of arsenic and antimony, owing to their toxicity, may be discouraged for environmental reasons in some applications. Fining vessel 126 is heated, for example to a temperature greater than the melting vessel interior temperature, thereby heating the fining agent. Oxygen produced by the temperature-induced chemical reduction of one or more fining agents included in the molten glass diffuses into gas bubbles produced during the melting process. The enlarged gas bubbles with increased buoyancy then rise to a free surface of the molten glass within the fining vessel and are vented from the fining vessel.

The downstream glass manufacturing apparatus 122 may further include another conditioning chamber, such as mixing apparatus 130, for example a stirring vessel, for mixing the molten glass that flows downstream from fining vessel 126. Mixing apparatus 130 may be used to provide a homogenous glass melt composition, thereby reducing chemical or thermal inhomogeneities that may otherwise exist within the molten glass exiting the fining vessel. As shown, fining vessel 126 may be coupled to mixing apparatus 130 by way of second connecting conduit 132. In some embodiments, molten glass 120 may be gravity fed from fining vessel 126 to mixing apparatus 130 by way of second connecting conduit 132. Typically, the molten glass within mixing apparatus 130 includes a free surface, with a free (e.g., gaseous) volume extending between the free surface and a top of the mixing apparatus. While mixing apparatus 130 is shown downstream of fining vessel 126 relative to a flow direction of the molten glass, mixing apparatus 130 may be positioned upstream from fining vessel 126. In some embodiments, downstream glass manufacturing apparatus 122 may include multiple mixing apparatus, for example a mixing apparatus upstream from fining vessel 126 and a mixing apparatus downstream from fining vessel 126. When used, multiple mixing apparatus may be of the same design, or they may be of a different design from one another. In some embodiments, one or more of the vessels and/or conduits may include static mixing vanes positioned therein to promote mixing and subsequent homogenization of the molten material.

Downstream glass manufacturing apparatus 122 may further include another conditioning chamber such as delivery vessel 134 located downstream from mixing apparatus 130. Delivery vessel 134 can condition molten glass 120 to be fed into a downstream forming device. For instance, delivery vessel 134 can act as an accumulator and/or flow controller to adjust and/or provide a consistent flow of molten glass 120 to a downstream forming and treatment apparatus 142 by way of delivery conduit 140. The molten glass within delivery vessel 134 can, in some embodiments, include a free surface, wherein a free volume extends upward from the free surface to a top of the delivery vessel. As shown, mixing apparatus 130 can be coupled to delivery vessel 134 by way of third connecting conduit 136.

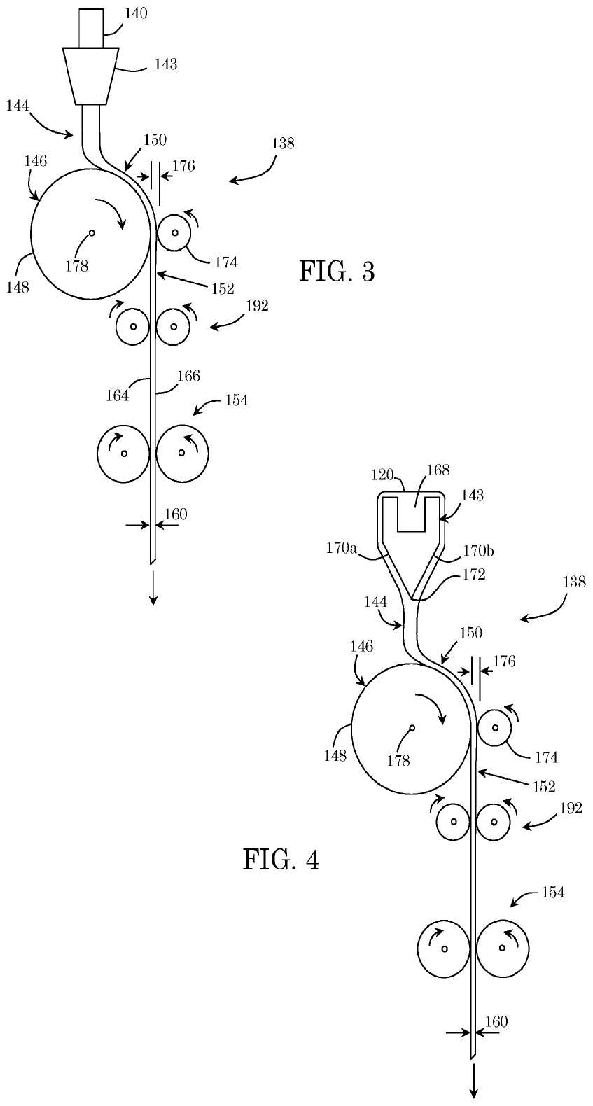

As described, downstream glass manufacturing apparatus 122 may further include a forming and treatment apparatus 142, wherein molten glass 120 is formed into a stream of molten glass and delivered to a treatment roller. As shown in FIG. 3, delivery conduit 140 can be positioned to deliver molten glass 120 from delivery vessel 134 to forming body 143 that forms part of forming and treatment apparatus 142. In some embodiments, such as that shown in FIG. 3, forming body 143 may be a slot-draw apparatus, wherein the forming body comprises a vessel including a slot along a bottom surface of the vessel where molten glass exits the vessel. Accordingly, forming body 143 delivers a stream 144 of molten glass to treatment roller 146 from the slot, wherein the stream 144 of molten glass is deposited on a circumferential (outer) surface 148 of the treatment roller as a glass layer 150. Treatment roller 146 may be a metallic roller formed from a metal that resists corrosion, for example a stainless-steel roller, although treatment roller 146 may be formed from other suitable metals. In various embodiments, treatment roller 146 may be hollow and supplied with a cooling fluid such as air or water. For example, treatment roller 146 may comprise one or more internal passages configured to convey the cooling fluid through the treatment roller and/or the cooling fluid may be sprayed against an internal surface of the treatment roller. Stream 144 of molten glass may impinge on treatment roller 146 at the 12 o'clock position (0 degrees, i.e., top dead center (TDC)) and form glass layer 150 on the treatment roller and then be released from the treatment roller at the 3 o'clock position (90 degrees) as glass ribbon 152. However, the glass ribbon may be released from treatment roller 146 at a different angular position, e.g., in a range from about 0 degrees to about 100 degrees, depending on adhesion of the molten glass to the treatment roller and/or the rotational speed of the treatment roller. Moreover, stream 144 of molten glass may impinge on the treatment roller at other than the 12 o'clock location. For example, either one or both of the stream 144 or the treatment roller 146 can be moved so the stream impinges on the treatment roller in a positional range from about 10 o'clock to about 2 o'clock (e.g., from about −30 to about 60 degrees relative to TDC).

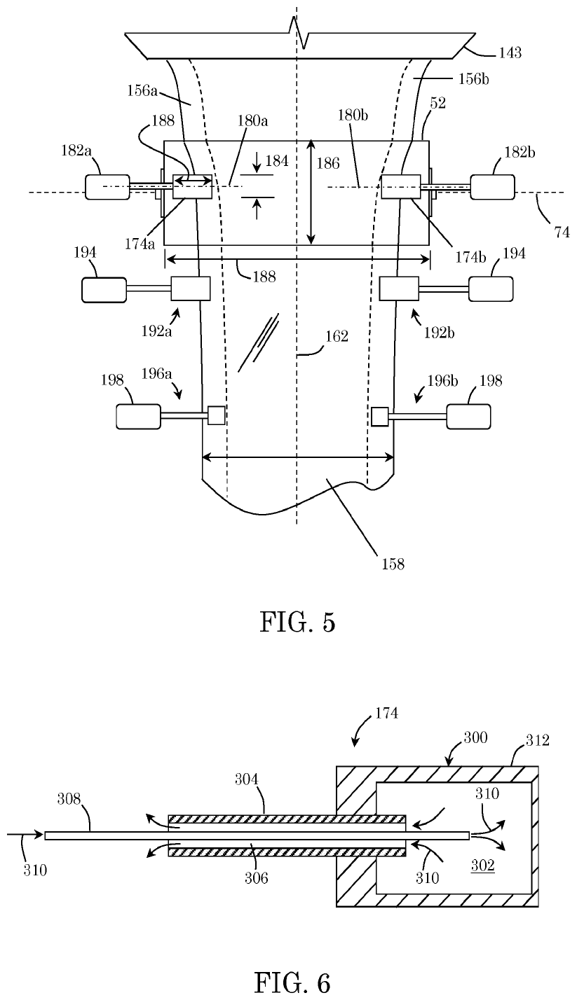

Glass ribbon 152 may be separated into individual glass sheets by a downstream glass separation apparatus (not shown). However, the glass ribbon may optionally be wound onto spools and stored for further processing. Glass ribbon 152 may be drawn downward from treatment roller 146 by a plurality of counterrotating pulling roll assemblies 154 positioned below treatment roller 146, pulling roll assemblies 154 (for example a pair of counterrotating pulling rolls) contacting glass ribbon 152 along edge portions 156a and 156b of the glass ribbon (see FIG. 5) without contacting central portion 158 of the glass ribbon, central portion 158 extending between edge portions 156a, 156b. A thickness 160 of glass ribbon 152 along a longitudinal centerline 162 of the glass ribbon can be defined between a first major surface 164 and a second major surface 166 of glass ribbon 152, wherein thickness 160 can be less than or equal to about 4 millimeters (mm), less than or equal to about 3 mm, less than or equal to about 2 mm, less than or equal to 1 mm, less than or equal to about 0.7 mm, equal to or less than about 0.5 mm, less than or equal to about 0.1 mm, equal to or less than about 500 micrometers (μm), such as less than or equal to about 300 μm, such as less than or equal to about 200 μm, or such as less than or equal to about 100 μm, although other thicknesses are contemplated. In addition, glass ribbon 152 can be formed from a variety of glass compositions including but not limited to soda-lime glass, borosilicate glass, aluminoborosilicate glass, an alkali-containing glass such as an alkali aluminoborosilicate glass, or an alkali-free glass.

FIG. 4 depicts another forming and treatment apparatus 142 wherein delivery conduit 140 (not shown in FIG. 4) delivers molten glass 120 to another forming body 143. In accordance with the forming body of FIG. 4, the forming body comprises a trough 168 located in an upper surface of the forming body, the forming body further comprising converging forming surfaces 170a and 170b that converge along a bottom edge 172 of forming body 143. Molten glass 120 overflows walls of the trough and flows down and over the converging forming surfaces. The separate flows of molten glass join along bottom edge 172 to form stream 144 of molten glass that is then deposited on treatment roller 146 as glass layer 150. Thereafter, the embodiment of FIG. 4 operates as the embodiment of FIG. 3.

Components of downstream glass manufacturing apparatus 122, including any one or more of connecting conduits 124, 132, 138, fining vessel 126, mixing apparatus 130, delivery vessel 134, delivery conduit 140, or forming body 143 may be formed from a precious metal. Suitable precious metals include platinum group metals selected from the group consisting of platinum, iridium, rhodium, osmium, ruthenium and palladium, or alloys thereof. For example, downstream components of the glass manufacturing apparatus may be formed from a platinum-rhodium alloy including from about 70% to about 90% by weight platinum and about 10% to about 30% by weight rhodium. However, other suitable metals for forming downstream components of the glass manufacturing apparatus may include molybdenum, rhenium, tantalum, titanium, tungsten, or alloys thereof. In the embodiment of FIG. 4, forming body 143 may comprise a refractory material, for example a ceramic refractory material.

An edge roller 174 may be used to contact glass layer 150 at the lateral edge portions of the glass layer, cool the glass at the lateral edge portions, and aid in mitigating attenuation of the glass layer and or ribbon drawn from the treatment roller. Accordingly, these functions may be performed while the glass layer resides on treatment roller 146, or, if edge rollers are included below the treatment roller (e.g., downstream edge rollers), they may be performed on the glass ribbon. For example, a pair of downstream edge rollers 174 may be used, the edge rollers capturing (e.g., pinching) glass layer 150 in a gap 176 between the edge rollers and the treatment roller. Edge rollers are typically metal, for example a metal that resists corrosion such as stainless steel, although other suitable metals may be employed.

FIG. 5 is a front elevational view of treatment roller 146 rotatable about a first axis of rotation 178, a first edge roller 174a rotatable about a second axis of rotation 180a, and a second edge roller 174b rotatable about a third axis of rotation 180b, wherein first and second edge rollers 174a and 174b are spaced apart so as to contact opposing edge portions 156a, 156b, respectively, and wherein second axis of rotation 180a may be coaxial with third axis of rotation 180b. First edge roller 174a and second edge roller 174b are spaced apart from treatment roller 146 such that gap 176 exists between the first and second edge rollers and the treatment roller, gap 176 sized to receive first and second edge portions 156a, 156b respectively. First and second edge rollers 174a, 174b contact glass layer 150 in contact with treatment roller 146, the edge rollers pressing the edge portions against the treatment roller, cooling the edge portions, and increasing a viscosity thereof, thereby reducing lateral contraction of glass layer 150. First edge roller 174a and second edge roller 174b may be coupled to respective motors 182a, 182b configured to rotate the respective edge rollers in a direction opposite a direction of rotation of treatment roller 146. As shown, first and second edge rollers 174a, 174b may be smaller than treatment roller 146. For example, a diameter 184 of first and second edge rollers 174a, 174b can be in a range from about 2.5 cm to about 8 cm, such as in a range from about 3 cm to about 7 cm, in a range from about 3.5 cm to about 6.5 cm, or in a range from about 4 cm to about 6 cm, including all ranges and subranges therebetween. For comparison, a diameter 186 of treatment roller 146 can be in a range from about 5 cm to about 31 cm, in a range from about 5 cm to about 26 cm, in a range from about 5 cm to about 21 cm, in a range from about 5 cm to about 15 cm, in a range from about 5 cm to about 10 cm, in a range from about 31 cm to about 10 cm, in a range from about 31 cm to about 15 cm, in a range from about 31 cm to about 20 cm, or in a range from about 31 cm to about 25 cm, including all ranges and subranges therebetween. However, diameter 184 of first and second edge rollers 174a, 174b may be equal to or greater than diameter 186 of treatment roller 146.

First and second edge rollers 174a, 174b can have a length 188 in a range from about 1 cm to about 26 cm, for example in a range from about 1 cm to about 20 cm, in a range from about 1 cm to about 15 cm, in a range from about 1 cm to about 10 cm, in a range from about 1 cm to about 5 cm, in a range from about 10 cm to about 26 cm, in a range from about 15 cm to about 26 cm, in a range from about 20 cm to about 26 cm, including all ranges and subranges therebetween. First and second edge rollers 174a, 174b are configured and arranged to contact edge portions 156a, 156b, respectively, of glass layer 150 but not contact central portion 158 of the exposed (outward facing) at least one face of glass layer 150 (e.g., second major surface 166) residing on treatment roller 146. By comparison, an entirety of the width of first major surface 164 of glass layer 150 is in contact with a portion of treatment roller 146. Treatment roller 146 can have a length 188 in a range from about 25 cm to about 400 cm, for example in a range from about 50 cm to about 400 cm, in a range from about 75 cm to about 400 cm, in a range from about 100 cm to about 400 cm, in a range from about 125 cm to about 400 cm, in a range from about 150 cm to about 400 cm, in a range from about 175 cm to about 400 cm, in a range from about 200 cm to about 400 cm, in a range from about 225 cm to about 400 cm, in a range from about 250 cm to about 400 cm, in a range from about 275 cm to about 400 cm, in a range from about 300 cm to about 400 cm, in a range from, about 25 cm to about 350 cm, in a range from about 25 cm to about 300 cm, in a range from about 25 cm to about 250 cm, in a range from about 25 cm to about 200 cm, in a range from about 25 cm to about 150 cm, in a range from about 25 cm to about 100 cm, or in a range from about 25 cm to about 75 cm, including all ranges and subranges therebetween.

First and second edge rollers 174a, 174b may have a variety of outside, circumferential surface finishes. For example, in some embodiments, first and second edge rollers 174a, 174b can have smooth outside surfaces, while in further embodiments, the outside, circumferential surfaces of first and second edge rollers 174a, 174b may be roughened, and in some embodiments, the outside surfaces may be knurled.

First and second edge rollers 174a, 174b may be cooled. For example, first edge roller 174a and second edge roller 174b may be hollow or comprise one or more passages therein through which a cooling fluid can be flowed. By way of example and not limitation, FIG. 6 depicts a cross-sectional view of an exemplary edge roller 174 comprising an edge roller body 300 containing an internal cavity 302. A shaft 304 comprising an interior passage 306 couples the edge roller body to a motor (not shown). A cooling fluid supply line 308 extends into cavity 302 through passage 306 defined within the shaft 304. A cooling fluid 310 is supplied to the coolant supply line from a coolant source (not shown) and exits the coolant supply line within cavity 302, wherein the coolant contacts the inside surface of the edge roller body, thereby cooling the edge roller body. Edge rollers 174 may have a smooth exterior contact surface 312 (surface contacting the molten glass or ribbon) or have a knurled or other patterned exterior surface.

Cooling of first and second edge rollers 174a, 174b may be controlled, for example, by controlling a flow rate and a temperature of the cooling fluid. Suitable cooling fluids can include water or air. The cooled first and second edge rollers 174a, 174b in turn cool edge portions 156a, 156b, increasing the viscosity of the edge portions. The stiffer edge portions (as a result of the increased viscosity) resist contraction of the molten glass layer. Thereafter, the molten glass layer is released from the outside circumferential surface of the treatment roller as a glass ribbon, wherein the increased viscosity of edge portions 156a, 156b resulting from contact with first and second edge rollers 174a, 174b further reduces contraction of glass ribbon 152 descending from treatment roller 146. The increased viscosity of glass ribbon 152 at the release point from treatment roller 146 can be in the range from about 103 Pa·s to about 106 Pa·s (10⁴ poises to 10⁷ poises), for example, about 103 Pa·s, 104 Pa·s, 105 Pa·s, or 106 Pa·s.

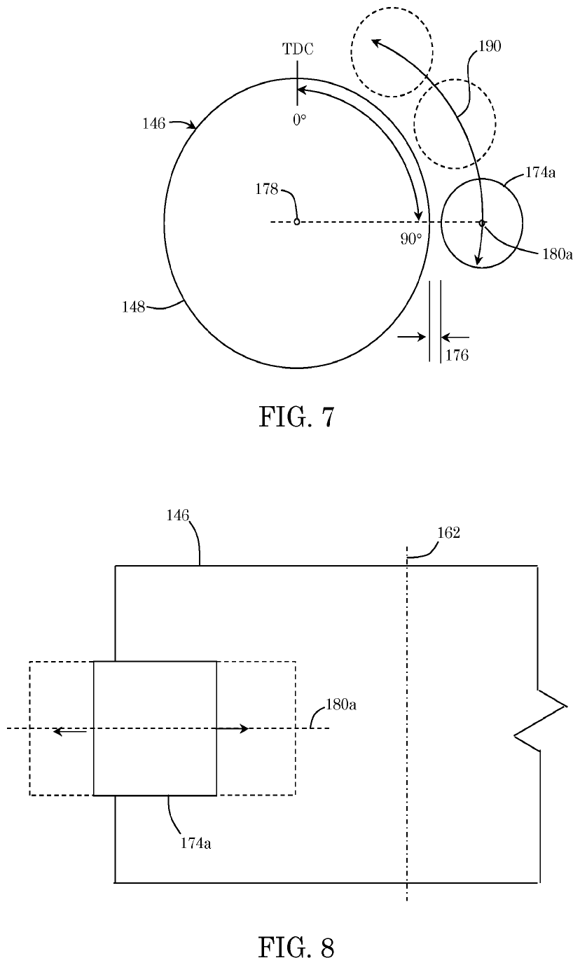

First and second edge rollers 174a, 174b may be movable in a vertical direction and/or a horizontal direction toward or away from treatment roller 146) so that first and second edge rollers 174a, 174b can be positioned along an arc 190 as shown in FIG. 7. Arc 190 may be concentric with the outer surface of treatment roller 146. First and second edge rollers may be positioned along arc 190 over an angular range from greater than 0 degrees to about 90 degrees (relative to TDC). Accordingly, first and second edge rollers 174a, 174b may contact glass layer 150 at any angular position along arc 190. Movement along the horizontal position toward or away from treatment roller 146 may also be used to increase or decrease gap 176 between the edge rollers and treatment roller 146. Additionally, first and second edge rollers 174a, 174b may be moved horizontally in a direction along axes of rotation 180a, 180b, respectively, as shown in FIG. 8 (showing movement of first edge roller 174a along second axis of rotation 180a).

Additional edge rollers 192 may be applied to glass ribbon 152 downstream from treatment roller 146. Such additional downstream edge rollers can act on edge portions 156a, 156b so that the outward facing second major surface 166 of central portion 158 of glass ribbon 152 remains free from contact. Such additional downstream edge rollers can act in counterrotating pairs on opposite edge portions of the glass ribbon. Accordingly, FIG. 5 also shows an additional set of downstream edge rollers 192 positioned downstream of treatment roller 146; a first pair 192a of opposing, counterrotating downstream edge rollers arranged along first edge portion 156a and a second pair 192b of opposing, counterrotating downstream edge rollers, arranged along second edge portion 156b. The opposing edge rollers of each pair 192a, 192b of downstream edge rollers is positioned adjacent opposing first and second major surfaces 164, 166 of glass ribbon 152 along the respective edge portions. The pairs 192a, 192b of downstream edge rollers 192 are configured to contact first and second edge portions 156a, 156b without contacting central portion 158 of glass ribbon 152. Downstream edge roller pairs 192a, 192b may move vertically toward or away from treatment roller 146. Downstream edge roller pairs 192a, 192b may also be moved horizontally along their respective axes of rotation. The downstream edge rollers 192 may be driven edge rollers. For example, at least one edge roller in each downstream edge roller pair may be coupled to a motor 194. In other examples, each edge roller in each downstream edge roller pair may be coupled to a drive motor 194. However, in still other instances, neither edge roller in each downstream edge roller pair may be driven. Edge rollers 192 may be identical in construction to edge rollers 174.

Pull roll assemblies 154 may be used to draw glass ribbon 152 from treatment roller 146. For example, pull roll assemblies 154 can comprise a pair of pull roll assemblies 154a, 154b, each pull roll assembly comprising a first pair 154a of opposing, counterrotating pulls rolls 196a and a second pair 154b of opposing, counterrotating pull rolls 196b. Pull roll pairs 196a, 196b apply a downward tension on glass ribbon 152 to control the travel speed of glass ribbon 152 and also the width and thickness of the glass ribbon. Pull roll pairs 196a, 196b may be any suitable design, but individual pull rolls can be comprised of a compressed refractory material, for example a plurality of fibrous ceramic discs arranged face-to-face, compressed, and mounted on a shaft. One or both pull rolls of each pull roll pairs may be driven, for example coupled to a motor 198.

Glass ribbon 152 may continue to be cooled as the glass ribbon descends below the pulling rolls. Any conventional methods and techniques for cooling a formed glass ribbon can be used, provided the glass ribbon and/or the at least one face of the glass ribbon remain undamaged.

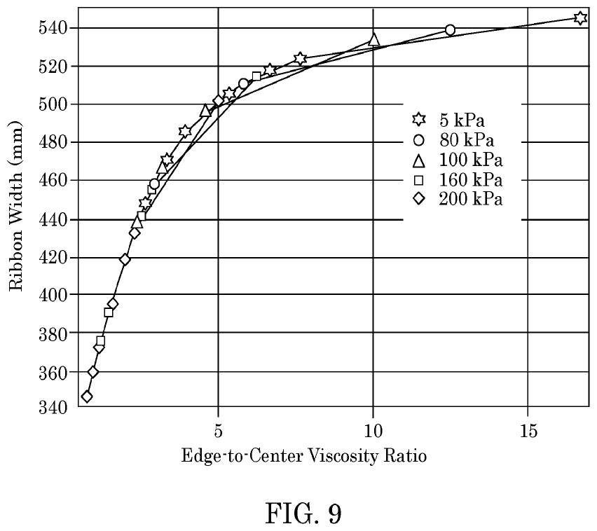

FIG. 9 is a chart showing modeled ribbon width in millimeters as a function of edge-to-center viscosity for five different glass ribbon center viscosities (viscosity at the center line of the glass ribbon at the take-off point from the treatment roller): 60 kilopoise (kpoise) (6 kPa·s), 80 kpoise (8 kPa·s), 100 kpoise (10 kPa·s), 160 kpoise (16 kPa·s), and 200 kpoise (20 kPa·s). The data show that glass ribbon width increases as the edge-to-center viscosity ratio increases. For the scenario considered in FIG. 9, approximately 200 mm of glass ribbon width can be obtained by increasing the edge-to-center viscosity ratio by about 15 times (15×). A 15× change in viscosity ratio is feasible by significantly cooling the edges of the ribbon using a contact heat transfer mechanism such as disclosed herein.

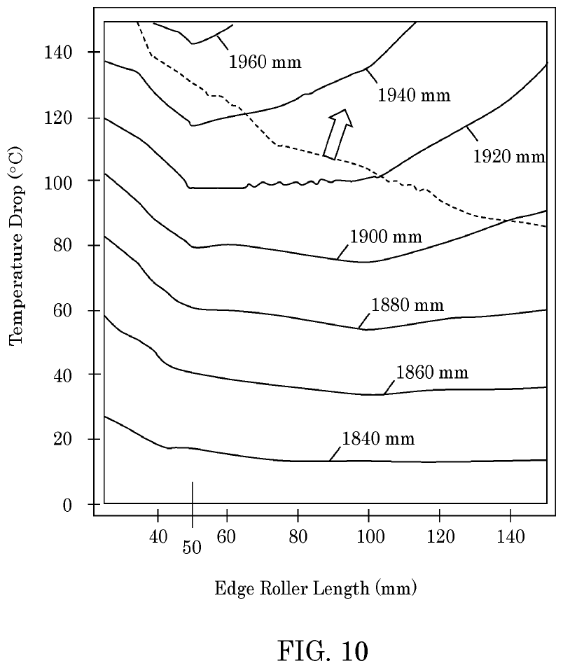

FIG. 10 is another chart using modeled data to show the impact to glass ribbon width as a function of temperature drop and edge roll length at the take-off point. The simulation assumes a treatment roller length of 205 cm. It can be seen from FIG. 10 that the first and second edge rolls can improve glass ribbon width from about 1.83 meters to about 1.93 meters (5-6% increase). It can also be observed that temperature drop is the main driver for glass ribbon width gain. Edge roller length has a moderate impact on glass ribbon width, but it may significantly affect pulling force. The dashed line in FIG. 10 represents the upper pulling force limit, which is defined by the pulling machine system and glass viscosity. Ribbon draw with higher forces may not be feasible for a given pulling machine above the upper pulling force limit (as indicated by the arrow in FIG. 10). For example, at an edge roller length of about 50 mm for the presented case, the ribbon width gain is maximal for the given pulling force limit. In addition, edge roller length can affect the cooling effectiveness of the edge rollers. The shorter the edge roller length, the smaller the amount of heat extracted from the molten glass.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

1. A method of forming a glass ribbon, comprising:
flowing a stream of molten glass on an outer surface of a treatment roller rotating about a first axis of rotation in a first direction of rotation, the stream of molten glass forming a molten glass layer on the outer surface of the treatment roller;
contacting an edge portion of the molten glass layer on the treatment roller with a first edge roller, the contacting cooling the edge portion and increasing a viscosity thereof, the glass layer leaving the treatment roller as a ribbon of molten glass, and wherein the first edge roller does not contact a central portion of the molten glass layer; and
drawing the ribbon of molten glass from the treatment roller in a draw direction between a pair of pulling rolls positioned below the treatment roller, the pair of pulling rolls engaging the edge portion on opposite sides of the glass ribbon.

2. The method of claim 1, further comprising contacting the edge portion with a pair of downstream edge rollers positioned between the treatment roller and the pair of pulling rolls.

3. The method of claim 1, wherein the stream of molten glass is flowed from a forming body.

4. The method of claim 3, wherein the stream of molten glass is flowed from a slot in the forming body.

5. The method of claim 1, further comprising cooling the first edge roller by contacting an interior surface of the first edge roller with a cooling fluid.

6. The method of claim 1, further comprising cooling the treatment roller by contacting an interior surface of the first edge roller with a cooling fluid.

7. The method of claim 1, wherein a diameter of the treatment roller is in a range from about 5 cm to about 31 cm.

8. The method of claim 1, wherein a length of the treatment roller is in a range from about 25 cm to about 400 cm.

9. The method of claim 1, wherein a diameter of the first edge roller is in a range from about 2.5 cm to about 8 cm.

10. The method of claim 1, wherein a length of the first edge roller is in a range from about 1 cm to about 26 cm.

11. The method of claim 1, wherein the treatment roller comprises a top defined at an angular position of 0 degrees, and the first edge roller contacts the glass layer on the treatment roller at an angular position in a range from about 35 degrees to about 90 degrees defined in a direction of rotation of the treatment roller relative to the 0 degree position.

12. The method of claim 1, wherein the first edge roller is movable along the second axis of rotation.

13. The method of claim 1, wherein the molten glass layer comprises a first viscosity at a first point on the edge portion and a second viscosity at a center point of the molten glass layer on a horizontal line extending orthogonal to the draw direction, and a viscosity ratio defined as a ratio of the viscosity of the molten glass layer at the first point to the viscosity of the molten glass layer at the center point is in a range from about 1 to about 16.

14. The method of claim 13, wherein the viscosity ratio is in a range from about 5 to about 15.

15. A method of forming a glass ribbon, comprising:
flowing a stream of molten glass on an outer surface of a treatment roller rotating about a first axis of rotation in a first direction of rotation by a first motor, the stream of molten glass forming a molten glass layer on the outer surface of the treatment roller:
contacting an edge portion of the molten glass layer on the treatment roller with a first edge roller rotated about a second axis of rotation in a second direction of rotation opposite the first direction of rotation by a second motor, the contacting cooling the edge portion and increasing a viscosity thereof, the molten glass layer comprising a first viscosity at a first point on the edge portion and a second viscosity at a center point of the molten glass layer on a horizontal line extending orthogonal to the draw direction, and a viscosity ratio defined as a ratio of the viscosity of the glass layer at the first point to the viscosity of the glass layer at the center point is in a range from about 1 to about 16, the molten glass layer leaving the treatment roller as a ribbon of molten glass; and
drawing the ribbon of molten glass from the treatment roller between a pair of pulling rolls in a draw direction, the pulling rolls engaging the glass ribbon on opposite sides of the glass ribbon below the treatment roller.

16. The method of claim 15, wherein the first edge roller does not contact a central portion of the molten glass layer.

17. The method of claim 16, wherein the treatment roller extends across an entire width of the molten glass layer in a direction orthogonal to the draw direction.

18. The method of claim 15, wherein a viscosity of the stream of molten glass at the treatment roller surface is in a range from about 10^{8.9} Pa·s to about 10^{10.2} Pa·s.

19. An apparatus for treating molten glass, comprising:
a delivery apparatus configured to deliver a stream of molten glass:
a treatment roller arranged below the delivery apparatus and positioned to receive the stream of molten glass as a molten glass layer on a surface of the treatment roller and release the molten glass layer as a glass ribbon; and
a first set of edge rollers arranged adjacent the treatment roller, the first set of edge rollers comprising a first edge roll positioned to contact the glass layer at a first lateral edge portion of the molten glass layer, but not a central portion of the molten glass layer, and press the first lateral edge portion against the surface of the treatment roller, and a second edge roll positioned to contact the glass layer at a second lateral edge portion of the molten glass layer opposite the first lateral edge portion, but not the central portion of the molten glass layer, and press the second lateral edge portion against the surface of the treatment roller.

20. The apparatus of claim 19, further comprising a set of pulling rolls positioned below the treatment roller, the set of pulling rolls comprising a first pair of pulling rolls arranged to capture the glass ribbon at a first edge portion of the glass ribbon and a second pair of pulling rolls arranged to capture the glass ribbon at a second edge portion of the glass ribbon, a first pulling roll of the first pair of pulling rolls coupled to a first motor configured to rotate the first pulling roll, and a second pulling roll of the second pair of pulling rolls coupled to a second motor configured to rotate the second pulling roll.

21. The apparatus of claim 19, further comprising a set of downstream edge rollers positioned between the treatment roller and the set of pulling rolls, the downstream set of edge rollers comprising a first pair of downstream edge rollers arranged to capture the glass ribbon therebetween at a first edge portion of the glass ribbon and a second pair of downstream edge rolls arranged to capture the glass ribbon therebetween at a second edge portion of the glass ribbon.
